(19) United States
(12) Patent Application Publication
(10) Pub. No.: US 2017/0039499 A1
(43) Pub. Date: Feb. 9, 2017

(54) Calendar Management with Online Marketing Interface

(71) Applicant: Flowh Patent Holdco, LLC, Loveland, CO (US)

(72) Inventor: Eric Darst, Centennial, CO (US)

(21) Appl. No.: 14/819,632

(22) Filed: Aug. 6, 2015

(51) Int. Cl. G06Q 10/06; G06Q 30/02

(52) U.S. Cl. CPC G06Q 10/06314; G06Q 30/0277

(57) ABSTRACT

An event management system may consolidate event listings into a calendar feed, which may be managed by a calendar owner. Users may subscribe to one or more calendar feeds, which may be aggregated into a single personal feed. A user may select individual events or groups of events to add to a personal schedule. As users interact with a calendar, the calendar owner may receive various analytical information about the users. The event management system may have various mechanisms to interact with the users, which may be as simple as sending reminders prior to the event.

### BACKGROUND

Calendar management is an age old problem. Many events vie for a person's time, including personal events such as a child's soccer practices, as well as business and educational conferences, and even entertainment events such as concerts or movies.

Awareness of an upcoming event is often a challenge for event organizers. Advertisements, from hanging posters on a bulletin board to television and radio are classic mechanisms to inform the public.

Attendance at an event is a very powerful, positive engagement for an event organizer. However, it is very difficult for event organizers to follow up and further engage with an attendee. For a small meeting, an organizer may pass out a sign up sheet, or a larger meeting may have some information for persons who purchase tickets.

### SUMMARY

An event management system may consolidate event listings into a calendar feed, which may be managed by a calendar owner. Users may subscribe to one or more calendar feeds, which may be aggregated into a single personal feed. A user may select individual events or groups of events to add to a personal schedule. As users interact with a calendar, the calendar owner may receive various analytical information about the users. The event management system may have various mechanisms to interact with the users, which may be as simple as sending reminders prior to the event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a calendar management system.

FIG. 2 is a diagram illustration of an embodiment showing a network environment showing a calendar management system.

FIG. 3 is a flowchart diagram of an embodiment showing a method for creating a calendar and event.

FIG. 4 is a flowchart diagram of an embodiment showing a method for consumer interactions with an event.

FIG. 5 is a flowchart diagram of an embodiment showing a method showing interactions with engagement tools.

FIG. 6 is a flowchart diagram of an embodiment showing a method showing interactions with a tracking system.

FIG. 7 is a flowchart diagram of an embodiment showing a method showing automatic augmentation of events.

### DETAILED DESCRIPTION

Calendar Management System for Marketing

A calendar management system may have many marketing tools for creating, managing, and tracking interactions with calendars. Such a system may have mechanisms for engaging calendar users, and may be a valuable marketing mechanism for certain industries.

Positive, effective engagement with customers may come from knowing which users have an affinity for a product or brand. Many online marketing systems may measure engagement by search requests for a product or brand, visits to various web pages, affirmation through social media engagement, but there are few interactions that are as powerful and meaningful as attendance at an event. Physical presence indicates a devotion of time and effort, which are very valuable assets, much more so than social media “likes”.

A calendar management system may have a management interface, a user or consumer interface, and several delivery vehicles. The management interface may have tools for creating a calendar entry as well as managing the interactions with a user or consumer. The consumer interface may aggregate multiple calendar streams and may have tools for browsing, selecting, and managing the consumer's preferred calendar feeds as well as interacting with specific events. The consumer interface may also enable calendar events to be integrated with a consumer's personal scheduling system. The delivery vehicles may include a website or application that may aggregate calendars for a consumer, plugins or embedded elements that may be displayed in a web page, or other vehicles.

The management interface may have tools for creating a calendar and events that become part of the calendar. An event may be defined with links to various services, which may be provided by third parties. The services may include different mechanisms for users to interact with the event, such as purchasing tickets, viewing video, audio, or web pages relating to the event, finding a location related to the event, or other interaction points.

The interaction mechanisms for an event may be defined within the calendar management system so that user interactions may be tracked. Because such services may be accessed through the event defined within the calendar management system, such interactions may be wrapped or instrumented by the calendar management system and reported to the calendar owner.

The level of a consumer's interaction with a calendar event may indicate the consumer's interest in the event or things related to the event. Such interactions may be used to target further advertisement or information about the event.

The consumer interface may include mechanisms for integrating events into a consumer's personal scheduling system. Many consumers may use a web, desktop, or mobile application for managing day to day schedules, and such applications may have a combination of personal, private, business, and other types of events and schedule related information. In many cases, a consumer's personal schedule may remain separate from the calendar management system and the consumer's personal or private information may not be accessible by the calendar management system.

A consumer may find the aggregated calendar system to be quite convenient. A system with aggregated calendars may allow for exploration and discovery of new calendars and events that may be of interest to the consumer. A consumer who may be interested in entrepreneurship may be able to discover calendars that have events such as meetings, conferences, seminars, that address the topic or related topics.

Another convenience element may be to add events to a personal scheduler. For example, a child's sports team schedule may also be available through the calendar management system. When selected, a consumer may be able to add or import the events to their personal scheduler without having to tediously add the events manually.

A consumer may find the aggregated calendar system useful when there are calendars of interest to the consumer. As the richness and completeness of the available calendar systems grows, the more likely a consumer may be to use the calendar management system for discovery and management of their calendars. Likewise, as the consumer becomes engaged with the calendar management system, the marketing value of the calendar management system increases as well, as a calendar owner's calendar may be exposed to or available to many more consumers.

Within this specification and claims, the term “calendar” is used to describe an event stream, which may contain one or more events. A calendar may typically have an “owner”, which may be a person, group, or device that may create events and add events to the calendar.

Within this specification and claims, an “event” may be defined by a time and, in some instances, location. Examples of events may be a concert performed at a given venue, an online webinar, a timed discount coupon, or other time-based events. In some cases, an event may have both a start time and end time, in other cases, an event may be defined with a single time. An event may also be associated with a time zone. Events may be defined using both a time and an implied or expressly defined time zone. In many cases, a time zone may be implied by assuming the default time zone for the user or device being used to create an event. Events may be displayed in the time zone of a recipient or that of the creator.

Within this specification and claims, the term “scheduler”, “schedule manager”, and “electronic scheduling system” are used to refer to an electronic device or application that may manage a person's personal schedule.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

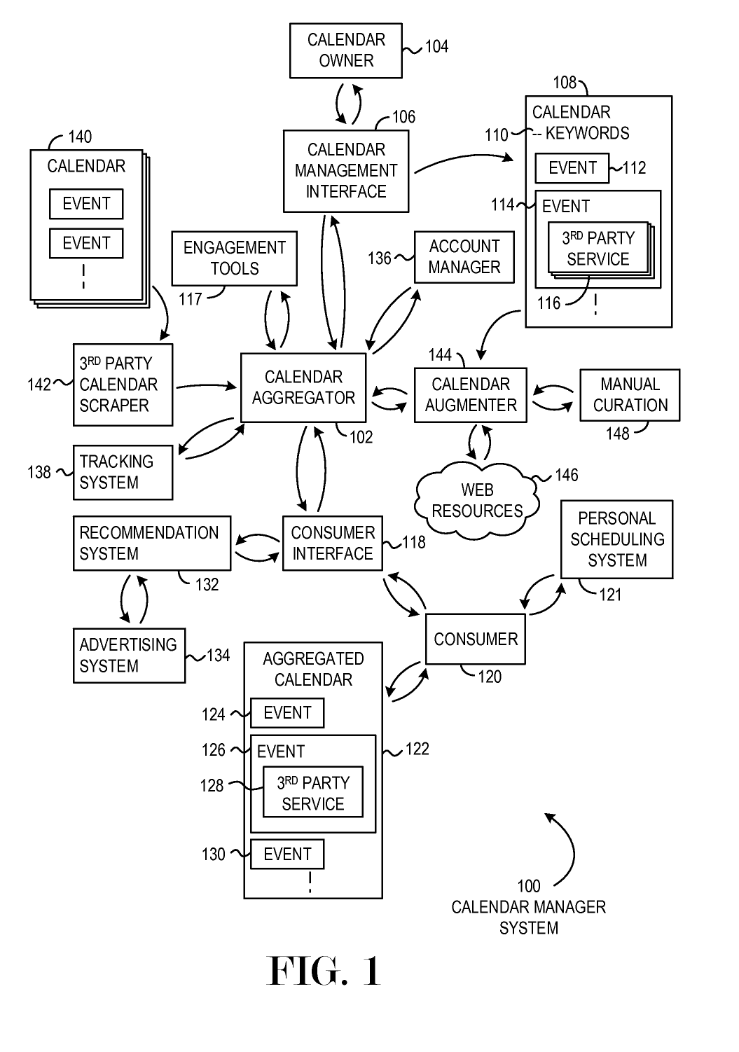

FIG. 1 is a diagram illustration of an embodiment 100 showing a calendar manager system. Embodiment 100 is merely one example of functional components that may make up a calendar manager.

Embodiment 100 illustrates a system where a calendar aggregator 102 may aggregate multiple calendars together for consumers. The calendar aggregator 102 may become a consumer's primary mechanism to collect, browse, and interact with calendars, and a place from which events may be added to the consumer's personal scheduling system. Calendar owners, which may be commercial enterprises, may create, manage, and track usage of events in their calendar stream. The system may afford calendar owners various mechanisms to engage consumers.

A calendar owner 104 may use a calendar management interface 106 to create a calendar 108.

A calendar 108 may have various keywords 110 and other classification mechanisms. Such classification mechanisms may aid in searching for the calendar, which may occur inside the calendar aggregator 102, in web search engines, and other search mechanisms.

Various events 112 and 114 may be created within the calendar 108. Events 112 and 114 may be any type time-based entity. Examples may include a sporting event, social meeting, business appointment, recreational activity, concert, or other event. Other examples may include an open enrollment period for an online service, a time-limited coupon or other promotion, or other entity.

Some events may have one or more physical locations, while other events may not have any associated location. For example, a concert or professional sporting event may have a location at a specific venue, while a television broadcast of the concert or sporting event may not have any location. In another example, a limited-time promotion for a restaurant chain may have multiple locations.

Many events may have a start and stop times, while other events may have only a single point in time. A business luncheon may have a start and end time, but a product launch may be defined as a point in time. Many events may be recurring events, that may have a defined periodicity. In some cases, such events may be identical for each instance, while other cases may have different instances of events.

Events may be defined with third party services 116. A third party service 116 may be any service that may be associated with the event. For example, a ticketing or RSVP service may be associated with an event, and such a service may be provided by a third party. In some cases, the third party services 116 may be various collateral that may be associated with the event. For example, a video or audio recording, website, or other collateral may be included in an event description. Such collateral may be viewed by a consumer.

Consumer engagement with third party services 116 may be tracked by the system as consumers interact with the services. Because the third party services 116 are defined within the system, the interactions may be wrapped or instrumented by a tracking system 138.

The calendar management interface 106 may have tools for creating, editing, and managing calendars and events. One example of such tools may be a suite of engagement tools 117, which may schedule interactions with consumers for an event. The engagement tools 117 may schedule reminders for upcoming events, among other things.

The engagement tools 117 may respond to consumer interactions. For example, when a consumer follows a calendar, a welcome message may be sent along with other scheduled messages over time or in response to events. When a consumer follows a specific event or adds the event to their personal scheduling system 121, the engagement tools 117 may send more details about an event, special offers relating to the event, reminders as the event draws near, offers to connect through social media, or other interactions. In some cases, the engagement tools 117 may be fully or semi-automated. Some systems may have an interface for manual interactions with consumers as well.

The calendar aggregator 102 may have a consumer interface 118 through which a consumer 120 may interact with the calendar 108 as well as other calendars. The consumer interface 118 may present an aggregated calendar 122, which may contain various events 124, 126, and 130. Some of the events, such as event 126, may have related third party services 128.

The aggregated calendar 122 may contain calendars from many different sources. In many cases, the consumer 120 may be able to explore other calendars, which may be referenced by keywords or other descriptors, venues and locations, or other characteristics. In many cases, a search engine may help locate calendars for viewing.

Calendars and events may be assigned various permission levels. For example, a calendar or event may be designated as public, such that anyone may see or interact with such a calendar or event. Some calendars or events may be designated as accessible by a group of people, and still others may be designated as private, where no other people may have access. Additional permission settings may permit some users to have full control, to be able to edit some portions of a calendar or event, or may be read-only.

In many systems, a consumer 120 may create and manage an account, and such a service may be provided through an account manager 136. An account may include various information about the consumer 120, such as identifying information for the user as well as the user's likes and dislikes. Such information may be used to identify additional calendars that may fit the consumer's interests.

A user account may also include various mechanisms by which the consumer 120 may be contacted. Such mechanisms may include electronic mail, a phone number for voice or text communication, social media connections, or other mechanisms. The calendar aggregator 102 may communicate with users about various calendars and events, such as sending reminders about upcoming events or announcements regarding calendars or events that the user may not have seen.

Some systems may permit a consumer to interact with one or more calendars without creating an account. Such interactions may not have as rich a user experience as interactions where a user may have an account.

A recommendation system 132 may suggest calendars for the consumer 120 to view and potentially follow. The recommendation system 132 may highlight calendars with similar characteristics to the consumer's likes and dislikes, as well as similar characteristics to calendars to which the consumer has already shown an inclination. In some cases, the recommendation system 132 may be influenced by an advertising system 134, which may cause specific calendars to be promoted within a set of recommendations.

A consumer 120 may interact with the consumer interface 118 to find calendars and events. The consumer 120 may be able to populate a personal scheduling system 121 with the calendars and events. The personal scheduling system 121 may be a component that may be integrated with the calendar aggregator 102 or may be a third party product.

A third party calendar scraper 142 may gather calendar information from third party resources, which may have calendars 140 and their related events. The calendar scraper 142 may gather calendar information from websites, applications, or other sources and populate calendars within the calendar aggregator 102 system.

Calendars gathered by the third party calendar scraper 142 may be available within the aggregated calendar 122. Such a service may be very useful to a consumer 120, as all of the calendars of interest to the consumer 120 may be available in a single user experience, even though the calendars may not have originated within the system.

When the aggregated calendar 122 shows externally-sourced calendars, the aggregated calendar 122 may become the consumer's primary source for events and calendar information. As the consumer 120 uses the aggregated calendar 122 more and more, advertisers and other calendar owners may be prompted to use the calendar management interface 106 to build and maintain calendars within the calendar aggregator system 102.

A calendar augmenter 144 may be a device or service that may add information to an event or calendar. The calendar augmenter 144 may identify content that users may browse, select, or interact. In many cases, such additional content may help explain or sell the event to a user. The calendar augmenter 144 may use various web resources 146 and may use manual or semi-automated curation 148. A description of a calendar augmenter 144 may be found later in this specification.

Consumer interaction with externally-sourced calendars 140 may be tracked with the tracking system 138, which may generate usage statistics for those usages within the calendar aggregator system. Such usage statistics may be presented in a report or other mechanism, and may be used to show the analytics potential of using the calendar management interface 106. Such calendar owners 104 may then subscribe to the system and enjoy full analytics for all interactions of their calendars, not just the interactions that occur through the calendar aggregator system.

The calendar aggregator 102 may provide websites, plugins, applications, application programming interface (API), or other interfaces to various content providers. For example, a calendar owner may create a calendar, then may use a plugin to their website to show calendar information. When the web page may be loaded, a call to the calendar aggregator 102 may return calendar information, which may be in HTML or other format, and the web page may be rendered with the calendar information. In another example, a cellular telephone application may call an API of the calendar aggregator 102 and request calendar information to display within the application. In some cases, such calendar information may be a specific calendar maintained by the application owner, although other cases may show calendar information from multiple owners.

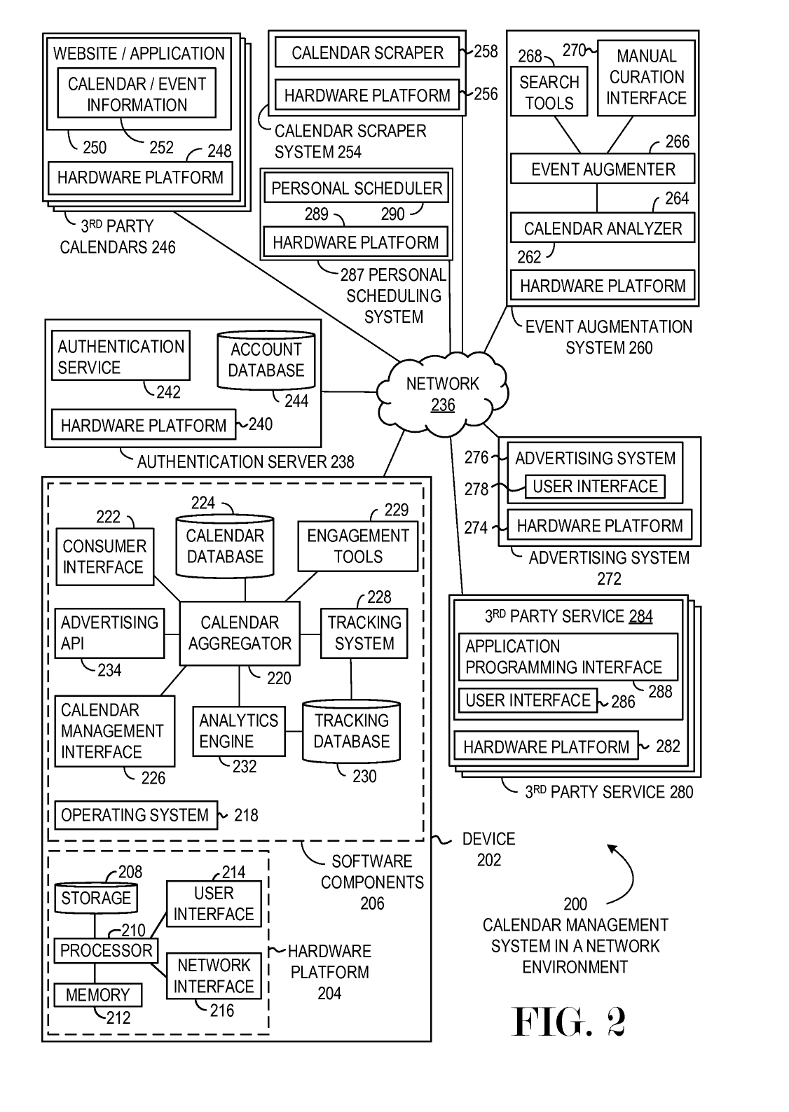

FIG. 2 is a diagram of an embodiment 200 showing components that may create, manage, display, and perform other operations with calendars and events. Embodiment 200 is merely one architecture that may illustrate various components that may interact to provide a calendar service. Other embodiments may have different architectures.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A calendar aggregator 220 may be a central service or application that may manage multiple calendars. The calendars may be accessed by a consumer through a consumer interface 222. The calendar information may be stored in a calendar database 224.

Calendars may be created, edited, and otherwise managed through a calendar management interface 226. Additionally, various engagement tools 229 may be configured by a calendar owner to interact with consumers through various mechanisms and in response to different actions that a consumer may take.

A tracking system 228 may log interactions between a consumer and various items in the calendar system. The tracking may include viewing a calendar or event, following a calendar or event, adding a calendar or event to a personal scheduling system, interacting with third party services through the calendar system, or other interactions. A tracking database 230 may store the various interactions and an analytics engine 232 may generate statistics and other analytics from these data.

The device 202 may be connected to a network 236.

An authentication server 238 may be a service that may run on a hardware platform 240 and may provide authentication service 242. The authentication service 242 may have an account database 244, where calendar owners and consumers may maintain accounts. The authentication service 242 may be a third party service instances.

Various third party calendars 246 may be any type of website, application, service, database, or other form of calendar data provided by a third party. Such services may operate on a hardware platform 248, which may support a website or application 250 in which various calendar or event information 252 may be accessible.

A calendar scraper system 254 may gather calendar information from the third party calendars 246 and add the third party calendar information to the calendar database 224. The calendar scraper system 254 may have a hardware platform 256 on which a calendar scraper application 258 may operate. The calendar scraper application 258 may have various interfaces through which it may gather or scrape information from the applications 250, format the information, and store the information in the calendar database 224.

An event augmentation system 260 may automatically or manually add information to event and calendar listings in the calendar aggregator system. The event augmentation system 260 may provide details about an event or other collateral that may enhance a consumer's interaction with a calendar or event. In many cases, interactions with the event augmentations may be tracked to monitor the effectiveness of the augmentation.

The event augmentation system 260 may operate on a hardware platform 262, and may have a calendar analyzer 264 and an event augmenter 266. The calendar analyzer 264 may identify events and the context or other metadata about the events within a calendar, and the event augmenter 266 may add information to the event. The event augmenter 266 may use automated search tools 268, as well as a manual curation interface 270 through which a human may curate, manage, or suggest augmentations to an event or calendar.

An advertising system 272 may be a system that manages online advertisement. In this example, the advertising system 272 may be a third party service where an advertiser may pay for various online advertisements, one of which may be to promote specific calendars, events, or place advertisements alongside related calendars or events. The advertising system 272 may operate on a hardware platform 274 and may have an advertising application 276 with a user interface 278. The advertising application 276 may interact with an advertising API 234 to identify calendars and events for promotion or advertising. The API 234 may also provide statistics and other feedback to the advertising application 276.

Many third party services 280 may be incorporated into calendars and events. The third party services 280 may be passive enhancements or augmentations to a calendar or event description, as well as active services with which a consumer may interact. An example of a passive enhancement may be a video, graphic, or text that may be embedded in an event description, while an active service may be a ticketing or registration service with which a consumer may interact to complete a purchase or RSVP for an event.

The third party services 284 may operate on various hardware platforms 282, and may include an application programming interface (API) 288 as well as a user interface 286. In many cases, a link may be provided within an event through which a third party service 284 may be accessed. A consumer may interact with the third party service 284 through the user interface 286, and the API 288 may communicate with the calendar aggregator with the results of the interaction.

Many consumers may have a personal scheduling platform 286 with which they manage their daily schedules. Sophisticated scheduling platforms may have web-based components, desktop applications, apps for mobile devices, and other interfaces through which a consumer may manage their day to day events. These systems may operate on various hardware platforms 288 and may run various personal scheduling systems 290.

The calendar system may have mechanisms for consumers to transfer or copy events from a consumer interface 222 to a personal scheduling system 290. Such a transfer may be through an application programming interface or other type of interface, and in many cases may be a transfer that is seamless or has very little consumer friction.

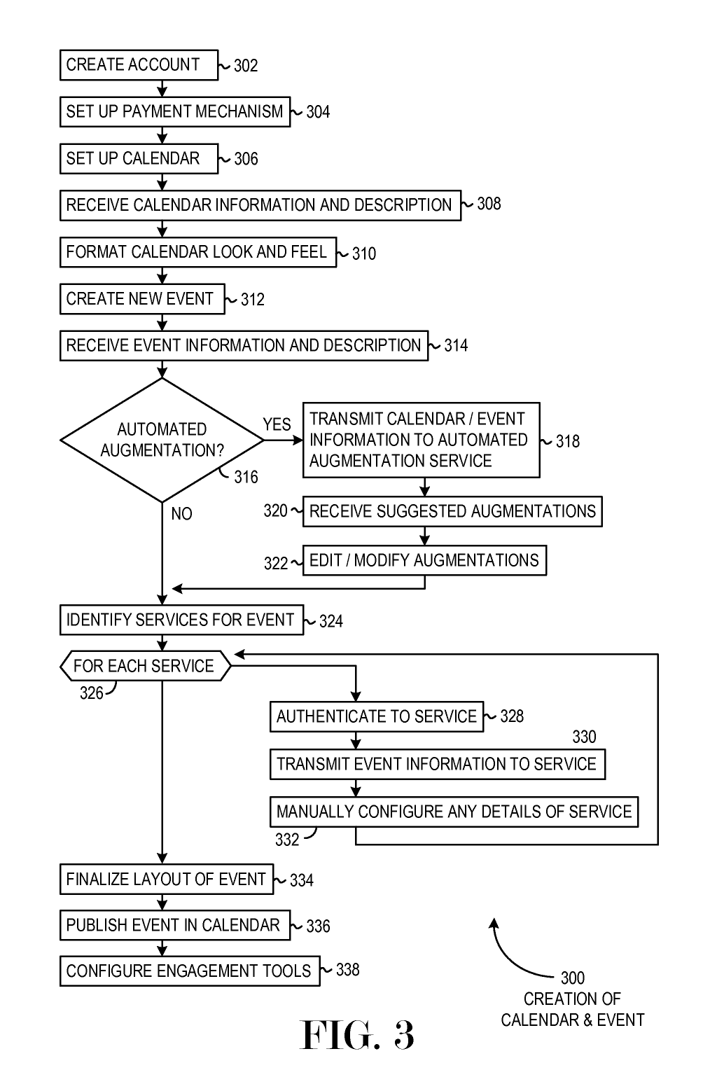

FIG. 3 is a flowchart illustration of an embodiment 300 showing a simplified example of operations to create a calendar and event.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may illustrate the actions that may be performed through a calendar management interface during the creation phase of a calendar and event.

A calendar owner may create an account in block 302. Some systems may require an account prior to use, while other systems may not require an account. Accounts may be useful so that a user may later return and edit content, receive responses, or other operations. An account may include providing an authentication mechanism, which often includes creating an account name and password. Creating an account may include associating a calendar management account with an existing account for which authentication may already be available, such as a social network that may authenticate as a third party service.

A payment mechanism may be set up in block 304. In a commercial version of a calendar aggregation system, the calendar owners may pay a fee for usage of the system. The fee may be a recurring fee, such as a monthly subscription. In some cases, the fee may be a pay-per-use fee, while in other cases, there may be tiered fees which may give access to higher volumes or increased features with higher payments.

A calendar may be set up in block 306. The set up operations may include receiving various calendar information and description in block 308 and configuring the calendar look and feel in block 310. The calendar information and description may include descriptors that a consumer may search, as well as general information that may apply to events in the calendar.

The look and feel of the calendar may be modified or edited in many different manners, including markup languages such as HTML, what-you-see-is-what-you-get editors, and other mechanisms. The look and feel may be adjusted for different ways that a calendar and events may be displayed.

A calendar aggregator may be capable of displaying calendars and events in many different formats and mechanisms. A calendar aggregator may have a website through which calendars and events may be browsed, selected, and manipulated. A plugin, code snippet, or other application may be available to include calendar information within other content, such as a web page, content management system, or other content. For each of the displayable mechanisms, the look and feel of the calendar and event content may be adjusted.

A new event may be received in block 312, and various event information and descriptions may be included in block 314. An event may include time and date, length of event, venue, topic, presenters, or any other information.

Automated augmentation may be selected in block 316. Automated augmentation may be a service that may add information to an event to augment the description. An example may be augmenting a concert event with the performer's discography, samples of their latest song, reviews from previous concerts, or other supplemental information. An augmentation service may find such information and suggest augmentations that may be quickly incorporated into an event description.

The calendar and event information may be transmitted to an automated augmentation service in block 318 and suggested augmentations may be received in block 320. A calendar owner may manually approve, edit, modify, or otherwise manipulate the suggested augmentations in block 322.

Various services that may be associated with the event may be identified in block 324. An example of a service may be a ticketing or RSVP service, transportation or lodging services, polling or questionnaire services, or other services.

In many cases, the services may be trackable in a one way manner, such that a tracking system may be able to determine when a consumer left an event description to engage the service. In other cases, the services may be able to be tracked in a two-way manner, such that the service may send an acknowledgement or other indicator when a user interacted with the service. The acknowledgement may be indicate, for example, that a consumer successfully completed an activity, quit without completing, as well as any statistics about the interaction. For example, a ticketing service may report back to the calendar tracking system that a consumer purchased four tickets to an event.

The process of adding services to an event may populate an event description with links or access to the various services. For each service in block 326, an authentication may be made to the service in block 328 and event information may be transmitted to the service in block 330. In some cases, a calendar owner may manually configure the services in block 332.

The layout of the event may be finalized and adjusted in block 334. The event may be published in block 336. In some instances, the publication of the event may include delaying the publication until a specific date and time. Publication may also involve announcing the event through various media, such as social media.

A set of engagement tools may be configured in block 338. The engagement tools may be automated mechanisms for communicating with consumers about the calendar and events. Engagement tools may, for example, send reminders about events, send updates when events change, transmit customized content to event followers, respond to actions taken by consumers, or other functions.

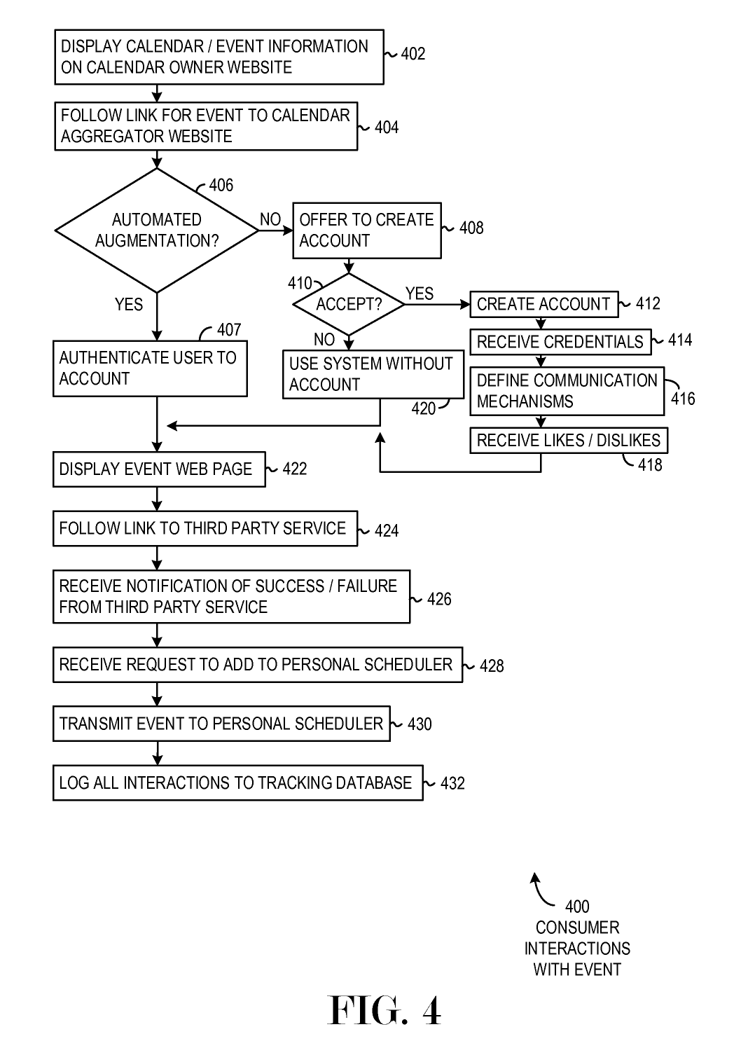

FIG. 4 is a flowchart illustration of an embodiment 400 showing a simplified example of operations for interactions between a consumer and a calendar and event.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 may illustrate operations that may be performed through a consumer interface to a calendar aggregator system.

Calendar and event information may be displayed in block 402. The display may be made through a website generated by a calendar aggregation system, application, plugin for another website, or other mechanism. In a typical display, a calendar may be displayed with multiple events. A user may select a specific event and a link may be followed in block 404 to display a web page for the event.

If a consumer has an account in block 406, the consumer may be authenticated to their account in block 407. If the consumer does not have an account in block 406, an offer may be made in block 408 to create an account. If the consumer accepts the offer in block 410, an account may be created in block 412, credentials may be established in block 414, and various communication mechanisms may be identified in block 416. The consumer may add their likes and dislikes in block 418, which may be used for recommending additional calendars.

If the consumer does not wish to create an account in block 410, the system may be accessed without an account in block 420. In a typical system, usage without an account may limit a consumer's access to various features of the system, such as receiving alerts and notifications among others.

The event web page may be displayed in block 422.

A consumer may select a third party service that may be displayed in an event description, and a link to the third party service may be followed in block 424. The consumer may interact with the third party service, and the service may transmit notification in block 426 with results from the interaction. In some cases, the notification may be success/failure, while in other cases, more detailed notification may be transmitted.

A request may be received in block 428 to add the event to a personal schedule, and the event may be formatted and transmitted in block 430. In some cases, the connection to a personal schedule may be a one-way or push connection where event information may be copied to the personal schedule. In other cases, a synchronized relationship may be established with the personal schedule such that updates, cancellations, changes, or other information may be updated as an event may change.

A log may be made of all interactions made with the system. The log may include interactions between the consumer and the system as well as interactions between the consumer and third party collateral and services.

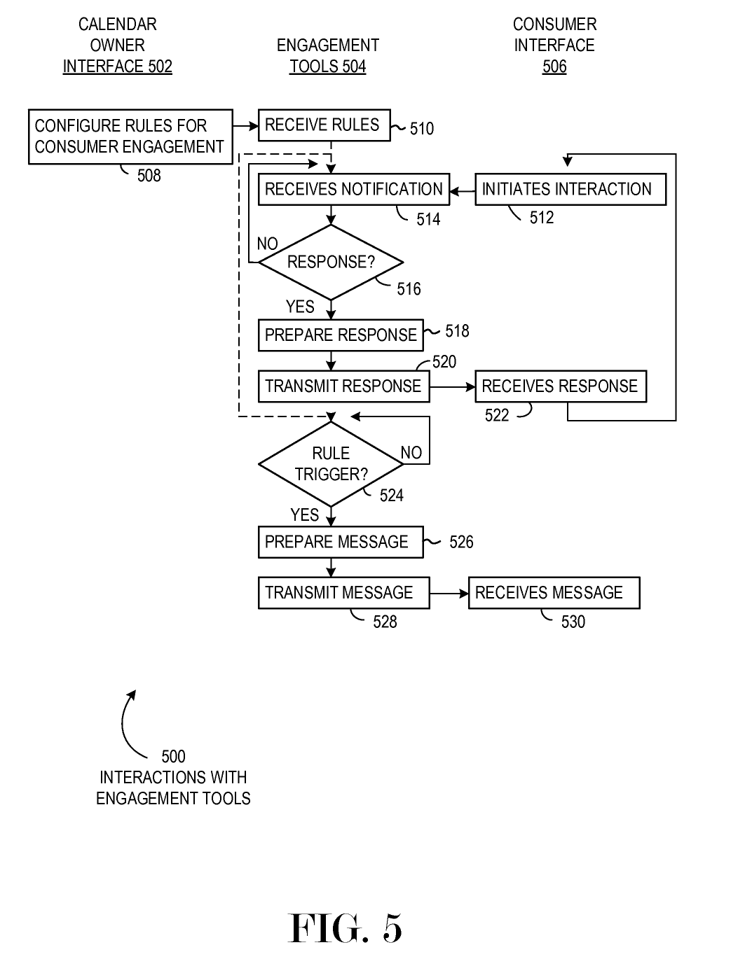

FIG. 5 is a flowchart illustration of an embodiment 500 showing a simplified example of interactions with an engagement tool.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 illustrates one simplified set of interactions that may occur between a calendar owner interface 502 in the left column, engagement tools 504 in the center column and a consumer interface 506 in the right column.

Within a calendar owner interface 502, rules for consumer engagement may be defined in block 508. In a typical usage, a set of default rules may be presented to a calendar owner with a set of preconfigured default parameters. A calendar owner may then adjust parameters, add or remove rules from a set of existing rules, create new rules, or make any other adjustments. In some cases, a rule system may include business logic defined in a programming language that may be interpreted or compiled prior to use.

Various rules may include communicating with the consumer through text, voice, electronic mail, various social media channels, or any other media. In many cases, the communications may be customized for each interaction, such as including the consumer's name and other fields. The communications may include reminders about an event, promotions or special offers for an event, thank you or follow up actions after an event, and others. The communications may be about calendars and events with which a consumer interacted in the past, as well as calendars and events that the consumer has not yet seen.

Rules may be created to trigger based on a consumer input or interaction. Rules may be created for interactions such as viewing a calendar or event, following a calendar or event, engaging with collateral or services associated with a calendar or event, success or failure for completing an interaction with a thirs party service, adding an event to a consumer's personal schedule, determining that a consumer attended or participated in an event, or other interactions.

Rules may also be create to trigger without consumer input. For example, a rule may send out electronic mail messages to consumers announcing a new calendar or event that may be of interest.

Some rules may have associated time parameters. For example, reminder messages may set to transmit a certain amount of time prior to an event. In another example, messages may be sent a certain amount of time after the last interaction.

A rule may have a message template that may be sent under a given condition. The message template may include text, graphics, video, or other information, as well as links or other connections to various web pages, applications, or other preconfigured elements. A message template may also include parameters that may be populated when a message is prepared for transmission, such as the consumer's name or various parameters about the event.

The engagement tools may receive the rules in block 510. When the rules are configured, two types of loops may be executed. The first loop may cycle based on input or interaction from a consumer interface 506. The second loop may cycle based on other triggers or conditions for a rule.

The examples in embodiment 500 illustrate interactions between a consumer interface 506 and engagement tools 504. In other cases, the engagement tools 504 may interact with third party services, application programming interfaces, and other services in a similar fashion.

A consumer may perform an interaction in block 512, and the engagement tools 504 may receive notification of the interaction in block 514. When a rule does not trigger a response in block 516, the loop may return to block 514 until another input may be received. When a rule does trigger a response in block 516, a response may be prepared in block 518 and transmitted in block 520. The response may be transmitted to a consumer in block 522.

Another loop may exist for rules that trigger on conditions that do not include the consumer interface 506. A simple example of such a rule may be to send out a notification of an event one week in advance. In such a rule, a loop may occur in block 524 while waiting for the conditions to be met. Once the conditions may be met, a message may be prepared in block 526 and transmitted in block 528 to be received in block 530.

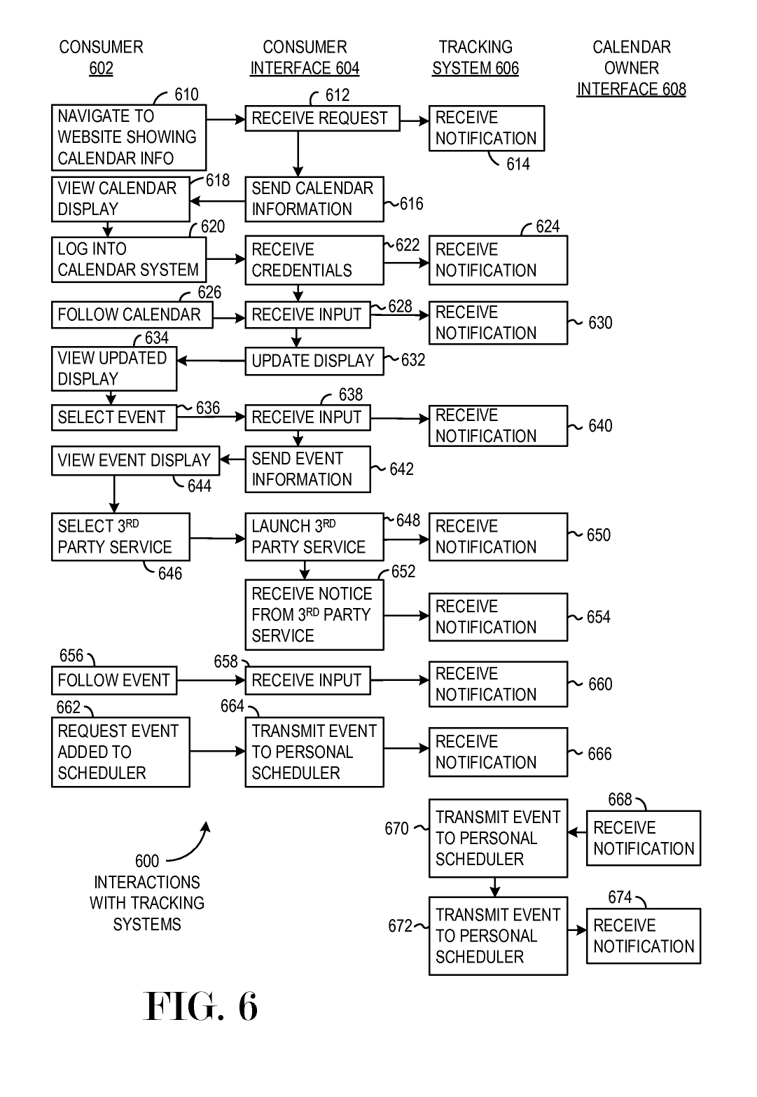

FIG. 6 is a flowchart illustration of an embodiment 600 showing a simplified example of interactions between a consumer 602 in the left column, a consumer interface 604 in the second column, a tracking system 606 in the third column, and a calendar owner interface 608 in the right column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 may illustrate some of the interactions between a consumer with a calendar aggregator system and some of the tracking operations.

A consumer 602 may navigate to a website containing calendar information in block 610. The calendar information may be provided through a calendar aggregation system and created by a calendar owner as described in other embodiments. A consumer interface 604 may receive a request from the website in block 612. A tracking system 606 may also receive a notification in block 614 of the request.

A consumer interface 616 may transmit calendar information in block 616 that a consumer 602 may view in block 618. A consumer 602 may log into the calendar system in block 620, and the authentication credentials may be received in block 622. A tracking system notification may be sent in block 624.

A consumer 602 may follow a calendar in block 626, and such a request may be received in block 628 and a tracking notification may be sent in block 630. The consumer interface 604 may update the display in block 632, which may be viewed by the consumer 602 in block 634.

A consumer 602 may select an event in block 636, which may be received by the consumer interface 604 in block 638. A notification may be sent to the tracking system 606 in block 640. The consumer interface 604 may update with the event information in block 642, which may be viewed by the consumer 602 in block 644.

A third party service may be selected by the consumer 602 in block 646, which may cause the consumer interface 606 to launch the third party service in block 648 and notify the tracking system 606 in block 650. Notice may be received in block 652 with results from the third party service, and such a notice may be communicated to the tracking system 606 in block 654.

A consumer 602 may follow an event in block 656, which may be received in block 658 and notification may be transmitted to the tracking system 606 in block 660.

A consumer 602 may request that an event be added to their personal schedule in block 662, which may cause the consumer interface 604 to transmit the event information to a personal schedule in block 664. Notification may be transmitted to the tracking system 606 in block 666.

A calendar owner interface 608 may receive a request for a report in block 668, which may be received by a tracking system 606 in block 670. The tracking system 604 may generate a report in block 672, which may be displayed by the calendar owner interface 608 in block 674.

Reports may be generated on any type of analysis of the tracking data. In some reports, a calendar owner may be shown the level of engagement between consumers and their events. Because each interaction may be tracked, including interactions with third party services, the reports may show statistics for the overall engagement and detailed interaction steps of the consumers, which services or collateral were used and their effectiveness, as well as the overall success of an event.

The reports may also incorporate interactions that may occur as a result of various engagement rules. Such statistics may include how the consumers responded to the engagement messages.

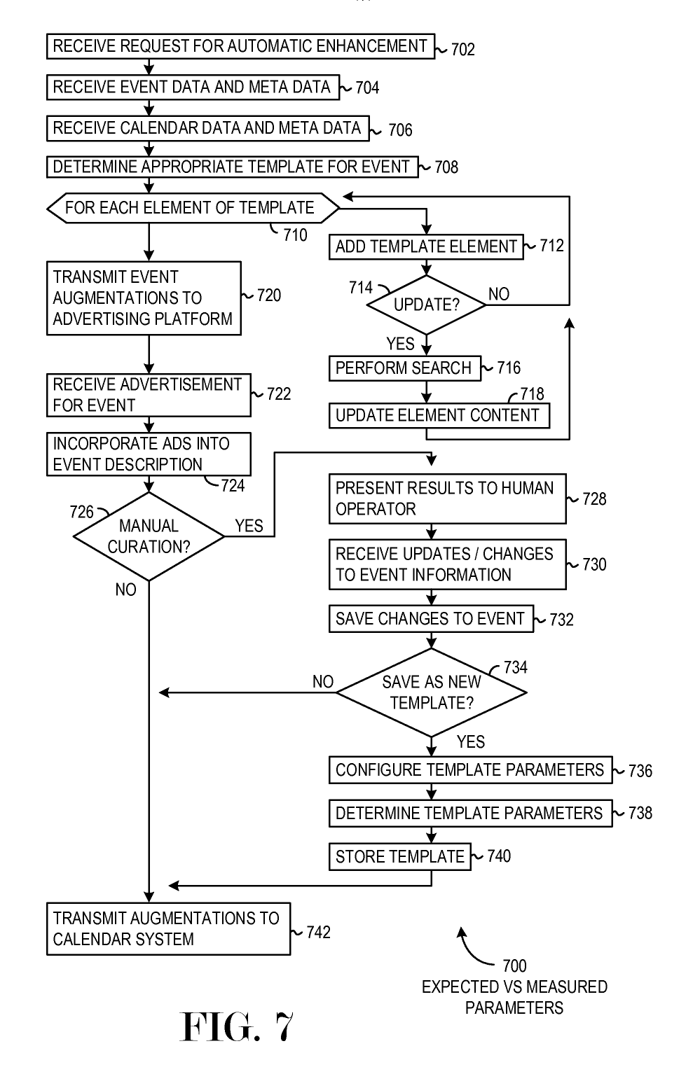

FIG. 7 is a flowchart illustration of an embodiment 700 showing a simplified example of automatic augmentation of events.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 700 shows one method by which events may be augmented with additional information, services, collateral, or other data. In many cases, an event organizer may define an event or set of events and may not include much data. Such events may be augmented with additional information, which may include support data, offers for related products, or other augmented information that may be related to the event. In many cases, such augmentations may make the event more attractive and add value to a consumer.

A request for automatic enhancement may be received in block 702, which may include event data and metadata in block 704 as well as calendar data and metadata in block 706.

The data received may be used to determine an appropriate template for an event. Some systems may have templates suited for specific types of events, such as concerts, sports events, recreational events, book readings, business events, or any type of events. In many cases, a calendar owner may create and maintain templates for their events, although in other cases the templates may be created and maintained by a different party than a calendar owner.

A typical template may include various elements that may be added to an event. In a simple example, template element may include a map or directions to an event with a specific location. Such a template may also include directions for parking, public or private transportation options, suggested restaurants in the area, or other information.

A template may include elements that provide background information or reviews of things relating to the event. For example, an event may include reviews of previous events by the same performer or events at the same location, as well as background information on the performer.

In some cases, a template may include elements that have information about attendees at the event or previous events. For a business networking meeting, for example, an event description may include demographic information about the types of people who plan on attending the event or have attended previous similar events.

In some cases, a template element may be static data that may be added to an event description and may not change. A map showing an event's venue may be an example of such an element. In other cases, a template element may be a dynamic element that may be updated. An example may be the attendee list of an event. Such dynamic elements may have a link to a service that may update the element when the elements may be requested for display.

For each element in a template in block 710, the template element may be added to an event description in block 712. In cases where the template element may be updated in block 714, a search may be performed in block 716 to gather the data to populate the element in block 718.

One example of such a process may be adding a map and directions to a venue. A map element may be added to an event description, and a search may be made to create the map illustration and populate directions to the event.

A template element may include third party services that may be added to an event description. For example, a ticketing or RSVP service may be added to the event description.

One use case for the automatic augmentation system of embodiment 700 may be to automatically augment event descriptions for third party calendars and events. In some cases, a third party may create an event and may use a service such as a ticketing service to sell tickets to the event. In such a use case, an automated augmentation system may scan the event description for third party services and may add the third party service to an augmented event description such that a calendar aggregator tracking system may be capable of tracking a consumer's use of the service.

The event information and augmentation elements may be transmitted to an advertising platform in block 720, which may return advertisements and offers for the event in block 722. The advertisements may be added to the event description in block 724.

The advertisements may include offers that may be tailored for the event. For example, an offer may include a coupon or other promotion for attendees to dine at a nearby restaurant prior to the event, or may include a parking discount or validation at a nearby parking garage for the evening of the event.

The advertisements may be dynamic offers or placeholders for offers that may be updated when the event may be displayed. In some cases, an offer may be added to the event that may include a third party service that a consumer may access through the event description.

Manual curation in block 726 may be a mechanism by which a human operator may curate the event description and may add, remove, or modify augmentations to an event. The results of the automated augmentation may be presented to the human operator in block 728, and the human operator may make updates or changes to the event augmentations in block 730. The changes may be saved in block 732.

The human operator may have the option to save the changes as a template in block 734. When the operator elects to save as a template in block 734, various template parameters may be added in block 736. The template parameters may include fields that may be automatically populated the next time the template may be used. The operator may also set parameters in block 738 that may define conditions for automatically selecting and using the template. The template may be saved in block 740.

The augmentations may be transmitted to the calendar system in block 742 to be displayed as part of an event description.

In some cases, an event may be displayed in different formats. For example, when shown in a calendar stream, an event may be displayed with limited size and text. When shown as a single entity, an event may be displayed with a much larger display area.

Some augmentations may be identified for display in different views of an event, and may be displayed one way in one view and a different way in another view. For example, in a compressed or smaller event view, an augmentation may be shown as a small icon, but in a larger event view, the augmentation may be shown with a detailed description, interactive buttons, or other elements.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A calendar management system comprising:
at least one processor;
a calendar manager interface configured to:
create a new calendar;
create a new event; and
associate said new event with said new calendar;
a consumer interface operable on said at least one processor, said consumer interface configured to:
display a plurality of calendars, said new calendar being one of said plurality of calendars;
receive a selection for said new event; and
transmit a communication comprising an identifier for said new event to a personal schedule application;
a tracking system configured to:
determine that a first consumer performed an interaction with said new event and generating a statistic, said interaction comprising selecting said new event; and
generating a display showing said statistic.

2. The calendar management system of claim 1, said interaction further comprising following said new calendar.

3. The calendar management system of claim 1, said calendar management interface further configured to:
add a traceable service to said event.

4. The calendar management system of claim 3, said tracking system further configured to:
determine that said first consumer interacted with said traceable service.

5. The calendar management system of claim 4, said tracking system further configured to:
receive an initiation indicator when said first consumer interacted with said traceable service.

6. The calendar management system of claim 4, said tracking system further configured to:
receive a completion indicator from said traceable service.

7. The calendar management system of claim 1, said consumer interface further configured to:
display a recommended calendar as one of said plurality of calendars.

8. The calendar management system of claim 7, said plurality of calendars comprising calendars followed by said first consumer and said recommended calendar.

9. The calendar management system of claim 7, said consumer interface further configured to:
determine an affinity for said first consumer, said recommended calendar being related to said affinity.

10. The calendar management system of claim 7, said recommended calendar being presented as an advertisement for said recommended calendar.

11. A process performed at least in part on a computer processor, said process comprising:
creating a new calendar;
creating a new event;
associating said new event with said new calendar;
associating said new event with a service;
displaying a plurality of calendars, said new calendar being one of said plurality of calendars;
receiving a selection for said new event;
transmitting a communication comprising an identifier for said new event to a personal schedule application;
determining that a first consumer performed an interaction with said new event and generating a statistic, said interaction comprising selecting said new event; and
generating a display showing said statistic.

12. The process of claim 11, said interaction further comprising following said new calendar.

13. The process of claim 11 further comprising:
adding a traceable service to said event.

14. The process of claim 13 further comprising:
determining that said first consumer interacted with said traceable service.

15. The process of claim 14 further comprising:
receiving an initiation indicator when said first consumer interacted with said traceable service.

16. The process of claim 14 further comprising:
receiving a completion indicator from said traceable service.

17. The process of claim 11 further comprising:
displaying a recommended calendar as one of said plurality of calendars.

18. The process of claim 17, said plurality of calendars comprising calendars followed by said first consumer and said recommended calendar.

19. The process of claim 17 further comprising:
determining an affinity for said first consumer, said recommended calendar being related to said affinity.

20. The process of claim 17, said recommended calendar being presented as an advertisement for said recommended calendar.
